(19) United States
(12) Patent Application Publication
(10) Pub. No.: US 2006/0226271 A1
(43) Pub. Date: Oct. 12, 2006

(54) Crusher and crushing method thereof

(76) Inventors: Seiichi Sakato, Chiba (JP); Yasuumi Minato, Chiba (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/549,162

(22) PCT Filed: Dec. 14, 2004
(86) PCT No.: PCT/JP04/18660

§ 371 Date: Jan. 4, 2006

(30) Foreign Application Priority Data
Dec. 15, 2003 (JP) 2003-417347

(51) Int. Cl. B02C 1/08

(52) U.S. Cl. 241/266

(57) ABSTRACT

An object of the present invention is to perform excellent crushing on an SRC object to be crushed or RC object to be crushed (pillar, beam or the like). In the crushing machine of the present invention, a crushing machine outer case is provided with movable jaw main bodies, base portions of the movable jaw main bodies are provided at the pivotally supporting portions that are separated from each other by a predetermined space, crushing bodies are fixed to the pointy ends of the movable jaw main bodies, the movable jaw main bodies being configured so as to be able to perform opening and closing movement by means of hydraulic cylinders, and crushing blade lines of the crushing bodies are formed so as to follow the longitudinal direction of the movable jaw main bodies.

### BACKGROUND OF THE INVENTION

1. Field of the Invention

The present invention relates to a crushing machine capable of performing excellent crushing on a SRC object to be crushed or RC object to be crushed (pillar, beam or the like), and a crushing method thereof.

2. Description of the Related Art

In Kobe earthquake, bridge beams on highways, large-size buildings, and the large numbers of buildings were collapsed. Most of them were built of reinforced concrete, that is, they were built with reinforced concrete (commonly called “RC”) pillars and beams. Buildings made of steel framed reinforced concrete, on the other hand, did not shake at all.

The reason is, as shown in FIG. 1 and FIG. 3, those buildings were built such that steel and rebar such as a wide flange beam, flat steel bar or the like are penetrated inside the concrete pillars or beams, around which the rebar is looped so as to be integrated with the concrete. This structure is called “steel framed reinforced concrete”, and commonly known as “SRC”. Recently, buildings with the SRC structure are prevailing. In the case where such buildings are crushed, since the buildings are strong and robust, it takes a quite hard crushing work.

Concretely speaking, a crushing machine having a beak is used to crush a concrete portion of the surface of a SRC object to be crushed (pillar, beam or the like), and then oxyacetylene welding flame is used to melt and cut a part of a steel product such as a wide flange beam, flat steel bar or the like exposed on the surface. Thereafter, the SRC object to be crushed is swayed appropriately to throw down a concrete pillar, which is the SRC object to be crushed. The drawbacks of such a work are that the work is not only significantly difficult but also time consuming, raising the construction cost. Moreover, there are drawbacks that such a crushing work is extremely dangerous, because usually there are workers who perform cutting standing near a pillar section, whereby the construction characteristics become greatly deteriorated. Further, as described in Japanese Patent Application Laid-Open No. 2001-65177, it was very difficult to crush pillars and the like of a SRC object to be crushed, even if the pointy end of the beak is used.

When performing a crushing work on a building structure such as a building made with a SRC object to be crushed or RC object to be crushed (pillar, beam or the like), the crushing work had conventionally been performed starting from the inside to the outside of the building, but a serious drawback in such a work was that a pillar or the like would fall or a part of the pillar would fall outside of the building, causing a fatal and injury accident involving passers-by. Prevention of such an accident was urgently needed in the crushing works of buildings.

Therefore, a crushing machine which is capable of crushing a SRC object to be crushed (pillar, beam or the like) safely and quickly, and a crushing method are desired. A problem (technical problem, object or the like) to be resolved by the present invention is to develop an apparatus which can safely and quickly crush a SRC object to be crushed (pillar, beam or the like), and a crushing method thereof. Another problem to be resolved is to avoid a serous drawback that a pillar or the like falls or a part of it falls outside when carrying out a crushing work on a building made with a SRC object to be crushed or RC object to be crushed (pillar, beam or the like), starting from the inside to the outside of the building.

### SUMMARY OF THE INVENTION

The above-described problems are solved by making a first invention as a crushing machine, in which a crushing machine outer case is provided with a pair of movable jaw main bodies which swing face to face with each other, base portions of the pair of movable jaw main bodies are provided at a pair of pivotally supporting portions which are separated from each other by a predetermined spacing, and crushing bodies are fixed to the pointy ends of the pair of movable jaw main bodies, the movable jaws main bodies being configured so as to be openable and closable by means of respective hydraulic cylinders. Further, the above-described problems are solved by making a second invention as the crushing machine according to the above configuration, in which crushing blade lines of the crushing bodies are formed so as to follow the longitudinal direction of the movable jaw main bodies. Furthermore, the above-described problems are solved by making a third invention as the crushing machine according to the above configuration, in which an intermediate pressing portion is formed in a protruding fashion in an intermediate position, on a working surface side, between the pointy ends and base portion of each of the movable jaw main bodies.

Also, the above-described problems are solved by making a fourth invention as a crushing method for crushing, in which crushing bodies are provided on the pointy ends of a pair of movable jaw main bodies which swing face to face with each other in a crushing machine outer case, and crushing blade lines of the crushing bodies are formed so as to follow the longitudinal direction of the movable jaw main bodies, thereby crushing a SRC object to be crushed or a RC object to be crushed such as a pillar or beam after pinching the pillar or beam such that the crushing blade lines of the crushing bodies intersect to the longitudinal direction of the object to be crushed, and repeatedly crushing the intersecting part.

Moreover, the above-described problems are solved by making a fifth invention the crushing method by means of the crushing machine according to the above configuration, in which little amount of reaction force for pushing out the SRC object to be crushed or RC object to be crushed is generated when closing the pair of movable jaw main bodies in the case of crushing a building from the inside to the outside thereof. The above-described problems are also solved by making a sixth invention as the crushing method by means of the crushing machine according to the above configuration, in which, with respect to the maximum space of the both pointy ends of the crushing bodies when the movable jaw main bodies are opened to the maximum, the ratio of the small space created when gradually closing the movable jaw main bodies so that both pointy ends of the crushing bodies come to the front-most positions, is approximately 5% or less.

The first invention exhibits the maximum effect that a SRC object to be crushed or a RC object to be crushed (pillar, beam or the like) can be crushed excellently. The second invention can make an excellent performance of crushing the SRC object to be crushed or RC object to be crushed (pillar, beam or the like). Further, the third invention can make an excellent performance of crushing the RC object to be crushed (pillar, beam or the like) in particular. Furthermore, the fourth invention has an effect that the SRC object to be crushed or RC object to be crushed (pillar, beam or the like) can be crushed more efficiently. Moreover, the fifth invention exhibits an effect of preventing the serious problems that can occur when a pillar or the like falls outside or a part of the pillar falls outside during a crushing work performed on a building made with RC objects to be crushed (pillar, beam or the like), starting from the inside to the outside of the building. The similar effect as the above invention is exhibited in the sixth invention as well.

### BRIEF DESCRIPTION OF THE DRAWINGS

FIG. 1 is a perspective view which shows that a pillar as a SRC object to be crushed is about to be crushed in a first embodiment of the present invention;

FIG. 2A is a front view of the first embodiment of the present invention;

FIG. 2B is a perspective view of a movable jaw main body with a crushing body;

FIG. 2C is a cross sectional view taken along the arrow X-X of FIG. 2A;

FIG. 3 is a partial operation diagram in which a plate portion of a steel wide flange beam or a flat steel bar of a pillar as a SRC object to be crushed is crushed;

FIG. 4 is a figure showing a state in which the both edge sides of the plate portion of a steel side flange beam or the flat steel bar of the pillar as a SRC object to be crushed are deformed and crushed by the crushing bodies facing each other;

FIG. 5A is an operation diagram showing a state immediately after starting crushing the plate portion of a steel wide flange beam or the flat steel bar of the pillar as a SRC object to be crushed in the first embodiment of the present invention;

FIG. 5B is an operation diagram showing that the crushing of the plate portion of a steel wide flange beam or the flat steel bar of the pillar as a SRC object to be crushed is progressed to an extent in the first embodiment of the present invention;

FIG. 6A is an operation diagram showing that the crushing of the plate portion of a steel wide flange beam or the flat steel bar of the pillar as a SRC object to be crushed is progressed to an extent in the first embodiment of the present invention;

FIG. 6B is an operation diagram showing that the crushing of the plate portion of a steel wide flange beam or the flat steel bar of the pillar as a SRC object to be crushed is further progressed in the first embodiment of the present invention;

FIG. 7A is a front view showing a substantial part of the first embodiment of the present invention;

FIG. 7B is an enlarged view of the substantial part of FIG. 7A;

FIG. 8 is a perspective view showing that a RC object to be crushed (pillar, beam or the like) is about to be crushed in a second embodiment of the present invention;

FIG. 9A is a front view of the second embodiment of the present invention;

FIG. 9B is a perspective view of the movable jaw main body of the second embodiment of the present invention;

FIG. 10A is an operation diagram immediately before starting crushing a pillar as a RC object to be crushed in the second embodiment of the present invention;

FIG. 10B is an operation diagram immediately after starting crushing the pillar as a RC object to be crushed in the second embodiment of the present invention;

FIG. 11A is an operation diagram showing that the crushing of the pillar as a RC object to be crushed is progressed to an extent in the second embodiment of the present invention;

FIG. 11B is an operation diagram showing that the crushing of the pillar as a RC object to be crushed approaches an end in the second embodiment of the present invention;

FIG. 12A is an operation diagram immediately before starting crushing the pillar as a RC object to be crushed in the second embodiment of the present invention;

FIG. 12B is an operation diagram showing that the crushing of the pillar as a RC object to be crushed approaches an end in the second embodiment of the present invention;

FIG. 13A is an operation diagram showing, from the lateral view, a state immediately after starting crushing the pillar as a RC object to be crushed in the second embodiment of the present invention;

FIG. 13B is an operation diagram showing, from the lateral view, a state in which the crushing of the pillar as a RC object to be crushed is progressed to an extent in the second embodiment of the present invention;

FIG. 13C is an operation diagram showing, from the lateral view, a state in which the crushing of the pillar as a RC object to be crushed approaches an end in the second embodiment of the present invention;

FIG. 14A is an operation diagram showing, from the lateral view, immediately before starting crushing the pillar as a SRC object to be crushed or RC object to be crushed by means of the present invention provided in a power shovel; and

FIG. 14B is an operation diagram showing, from the lateral view, a state in which the crushing of the pillar as a SRC object to be crushed or RC object to be crushed by means of the present invention provided in a power shovel approaches an end.

### DESCRIPTION OF THE PREFERRED EMBODIMENTS

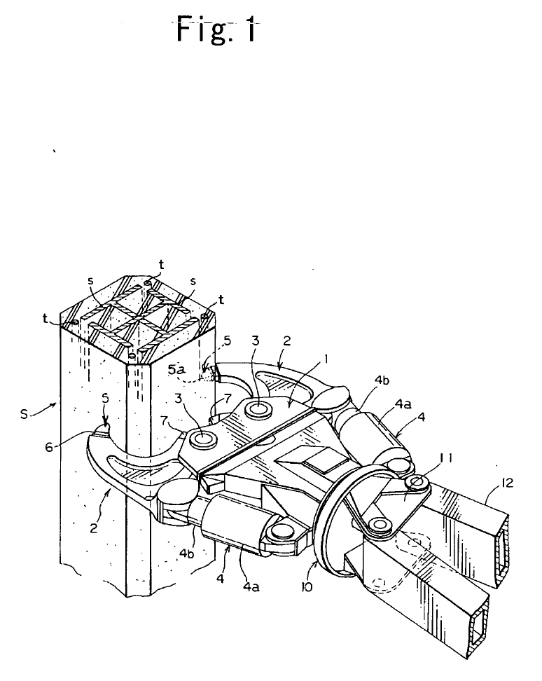

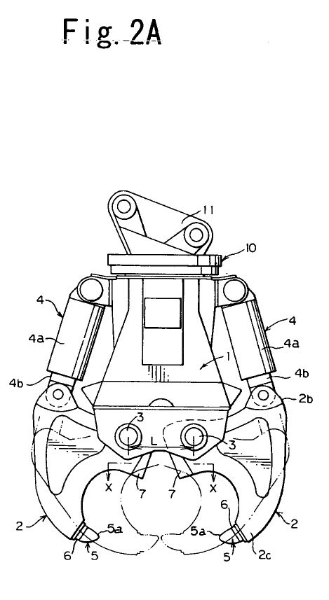

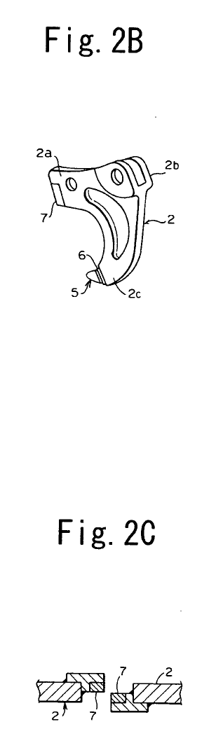

Hereinafter a first embodiment of the present invention is described with reference to the drawings. The crushing machine of the present invention shown in FIG. 1 and FIG. 2 mainly comprises a crushing machine outer case 1, movable jaw main bodies 2, 2, with a pair of crushing bodies 5, 5, a pair of pivotally supporting portions 3, 3, a pair of hydraulic cylinders 4, 4, and the like. Base portions 2a, 2a of the movable jaw main bodies 2, 2 are pivoted on the crushing machine outer case 1, and the movable jaw main bodies 2, 2 are configured openably and closably.

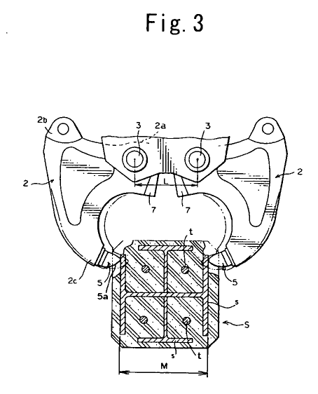

Here, the sides where the movable jaw main bodies 2, 2 face each other in the opening/closing direction are referred to as working surfaces for the movable jaw main bodies 2, 2, and the sides opposite of the working surfaces are referred to as outer sides. Moreover, the longitudinal direction of the movable jaw main body 2 is a direction from the base portion 2a side of the movable jaw main body 2, which is pivotally supported, to the a pointy end 2c side, and the width direction is a direction that intersects with the longitudinal direction at right angles. Particularly, the pair of pivotally supporting portions 3, 3 are separated from each other by a predetermined space L (see FIG. 3). The predetermined space L corresponds to the size of the crushing machine.

The movable jaw main bodies 2, 2 are in the form of a rough triangle, and the base portion 2a thereof is provided on in the pivotally supporting portion 3. A pointy end of a piston rod 4b of the hydraulic cylinder 4 is pivotally supported in an intermediate position 2b on the outer side of the movable jaw main body 2. A cylinder body 4a of the hydraulic cylinder 4 is provided in an upper end of the crushing machine outer case 1 so as to be freely turned on the page space in FIG. 2. The pair of movable jaw main bodies 2, 2 facing each other are opened and closed due to the telescopic motion of the piston rods 4b, 4b of the pair of hydraulic cylinders 4, 4.

The pointy end 2c of the movable jaw main body 2 is provided with the crushing body 5 with a crushing blade line 5a for crushing, via a crushing body attaching portion 6. Specifically, when the pair of movable jaw main bodies 2, 2 with the crushing bodies 5, 5 facing each other perform opening and closing movement, a pillar or the like, such as an object to be crushed S, is held from both sides of the movable jaw main bodies to strip off the surface of the concrete, and then a steel s of an exposed wide flange beam or flat steel bar of a SRC (steel framed reinforced concrete) object to be crushed S (pillar, beam or the like) is deformed and broken, and at the same time the concrete that is present inside of the steel s of the wide flange beam or flat steel bar is crushed.

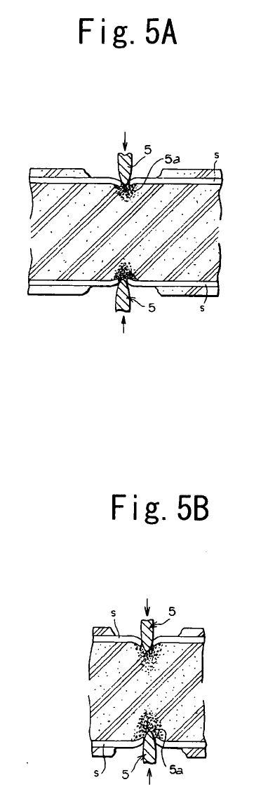

The crushing body 5 is in the form of a roughly halved piece of abacus, but the examples of the shape include a halved disk with a sharpened rim, and the like. In addition, it may have the form of a straight tooth. A straight tooth indicates a tooth as the one shown in a cross section in FIG. 5, which is formed to have a predetermined length. The portion forming a line of a blade for crushing, such as the pointy end or rim of the crushing body 5 is the crushing blade line 5a, and the direction in which the crushing blade line 5a is formed is such that it faces to the same direction as the longitudinal direction of the movable jaw main body 2. As the material of the crushing body 5, there is a hard metal material, tool steel or the like. Particularly, a hard metal material which is even harder can be provided only in the section of the crushing blade line 5a. Moreover, as shown in FIG. 1, FIG. 2 and the like, the crushing body 5 is attached to the pointy end of the movable jaw main body 2, by means of the plate like crushing body attaching portion 6. There is also a way to attach the crushing body 5 without using the crushing body attaching portion 6.

Even when closing the pair of jaw main bodies 2 configured as above, the pair of crushing bodies 5, 5 are configured such that the pointy ends thereof do not touch each other. Furthermore, the intersecting portions of the base portions 2a, 2a of the pair of movable jaw main bodies 2, 2 are provided with cutting portions 7, 7 made of steel wire such as a rebar. Accordingly, by swinging the cutting portions 7, 7 so that they intersect with each other, a cutting operation can be carried out (see FIG. 2C).

Furthermore, an end at a rear portion of the crushing machine outer case 1 (the right side in FIG. 1, and the upper side in FIG. 2) is provided with a rotating body 10 which can rotate by a predetermined angle and can stop at the position after the rotation, so the object to be crushed S can be cut or crushed at the best angle. A reference numeral 11 is a bracket for attachment which is attached to the external surface of the rotating body 10. A reference numeral 12 is a work arm pointy end portion of a hydraulic shovel. The crushing blade line 5a of the crushing body 5 is formed so as to face toward the longitudinal direction, but the length of the crushing blade line 5a may be made shorter to simply make the pointy end sharp. In this case, the crushing blade can correspond to an appropriate place on the steel s as a plate portion of a wide flange beam or a flat steel bar of the SRC object to be crushed S (pillar, beam or the like) by increasing the number of crushing operations by several numbers of times.

The operations are described next. As shown in FIG. 1, the crushing machine of the present invention is attached to the work arm pointy end portion 12 of a hydraulic shovel, the rotating body 10 is rotated by an appropriate angle with respect to the pillar of the SRC object to be crushed S so that the pair of crushing bodies 5, 5 of the pair of movable jaw main bodies 2, 2 in the crushing machine outer case 1 face each other at a substantially horizontal position, and then the pair of movable jaw main bodies 2, 2 facing each other are opened and closed repeatedly, whereby the concrete around the pillar body is stripped off by the pointy ends of the crushing bodies 5, 5. This work can be carried out. extremely simply.

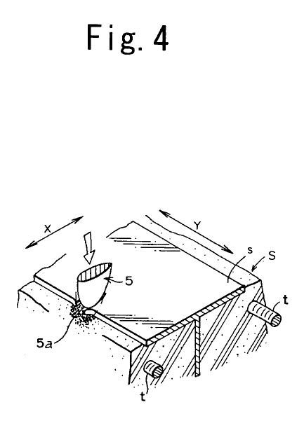

Then, when the steel s of the wide flange beam or flat steel bar of the pillar of the SRC object to be crushed S is exposed, the crushing blade lines 5a as the pointy ends of the crushing bodes 5, 5 intersect with each other at right angles (in the X direction shown in FIG. 4, which includes a direction in which they are at substantially right angles with each other) with respect to the longitudinal direction (Y direction in FIG. 4) of the steel s of the long plate portion of a wide flange beam or the flat steel bar, to press the pillar from the both sides. In this operation, normally the plate portion of a wide flange beam or the flat steel bar made of the steel s is filled with concrete, so it cannot be deformed. However, in this case it starts to be deformed, as shown in FIG. 5A, by causing the longitudinal direction of the crushing blade line 5a of the crushing body 5 to intersect with the longitudinal direction of the long plate portion of a wide flange beam or the flat steel bar made of the steel s (including the direction where they are substantially at right angles), and also by applying a concentrated load to a place on the edge sides of the plate portion of a wide flange beam or the flat steel bar made of the steel s. At this time the concrete filled inside the plate portion of a wide flange beam or the flat steel bar made of the steel s is buckled and destroyed only at the back of the deformed portion of the plate portion of a wide flange beam or the flat steel bar made of the steel s.

The reason for the deformation in the above manner lies in the press structure of the pair of crushing bodies 5, 5. That is, as shown in FIG. 3, the pair of pivotally supporting portions 3, 3 are configured so as to be separated from each other by a predetermined space L, whereby the pressing direction of the pair of crushing bodies 5, 5 is configured such that pressing and breaking force is applied substantially horizontally to the steel s of the wide flange beam or flat steel bar of the pillar body as the SRC object to be crushed, whereby the component force for pushing out towards the front (force that pushes out downward on the page space in FIG. 3) is eliminated mostly, thus the component force for pulling is generated, but most efficient crushing can be performed on a pillar body of a general SRC object to be crushed S. Concretely speaking, the predetermined space L is approximately 30 cm to 70 cm, and is a space M of the steel s of the wide flange beam or flat steel bar of a SRC pillar (specifically, approximately 40 cm to 100 cm).

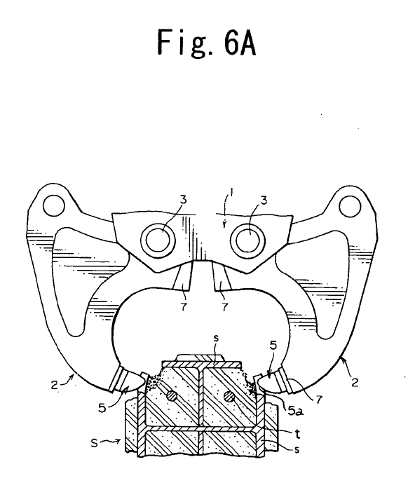

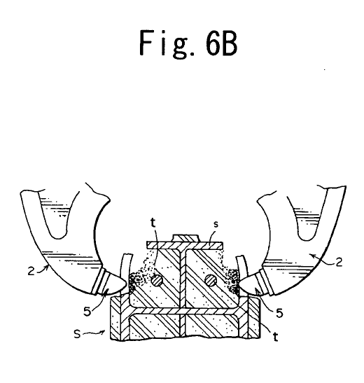

When the crushing is continued, as shown in FIG. 5B, the crushing is progressed as the steel s of the plate portion of a wide flange beam or the flat steel portion is deformed, and eventually some of it is cut off. This state is shown in FIG. 4. By repeating this process, numbers of appropriate places in the plate portion of a wide flange beam plate portion or the flat steel bar of the steel s is cut, as shown in FIG. 6A and FIG. 6B.

Next, through this cutting operation, by operating the pair of movable jaw main bodies so as to bend the uncrushed side of the pillar as the SRC object to be crushed S, that is, by operating the pair of movable jaw main bodies so as to bend the pillar in the vertical direction with respect to the page space in FIG. 6, the pillar as the SRC object to be crushed S can be crushed. In this work, cutting an appropriate place of the pillar or beam as the SRC object to be crushed S by means of oxyacetylene welding flame is hardly performed, thus the crushing work can be accelerated significantly. Moreover, there is an advantage that risk to the cutting workers can be avoided.

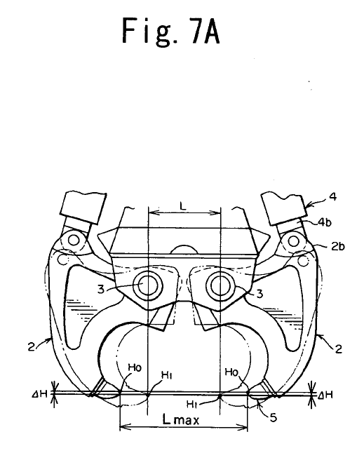

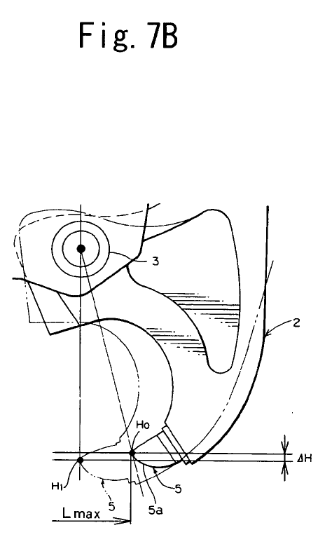

Further, in FIG. 7, when the positions of the pointy ends of the pair of crushing bodies 5, 5 when the pair of movable jaw main bodies 2, 2 are opened to the maximum are Ho₀, H₀, the space between the both H₀ on the right and H₀ on the left becomes the maximum space Lₘₐₓ (space in the horizontal direction in FIG. 7). Moreover, the space between the position H₀ when the pair of movable jaw main bodies 2, 2 are gradually closed from the positions H₀, H₀ of the pointy ends of the pair of crushing bodies 5, 5 so that the pointy ends of the pair of crushing bodies 5, 5 come to the front-most positions H₁, H₁ (position in a vertical direction in FIG. 7), and the front-most position H₁ becomes a small space ΔH (space in the vertical direction in FIG. 7). The ratio of the small space ΔH to the maximum space Lₘₐₓ is made approximately 5% or less. Specifically, (Small Space ΔH)/(Maximum Space Lₘₐₓ)≦approximately 0.05. Mostly the small space ΔH is approximately 5 cm to 10 cm.

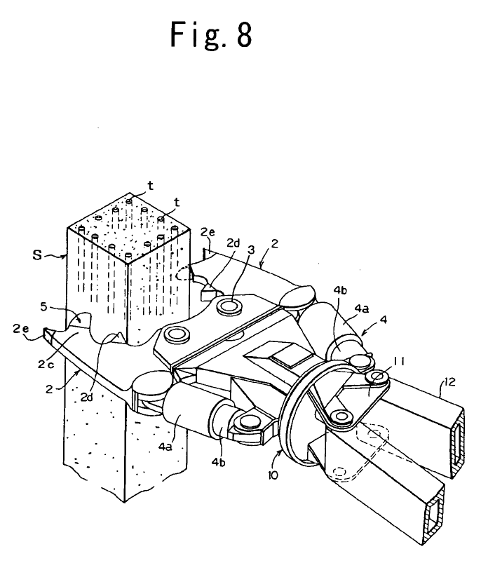

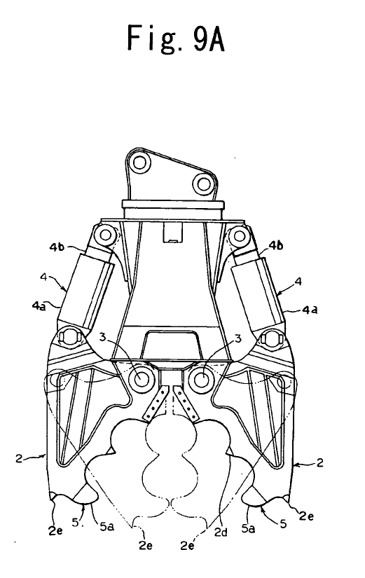

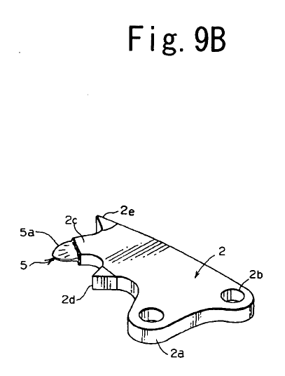

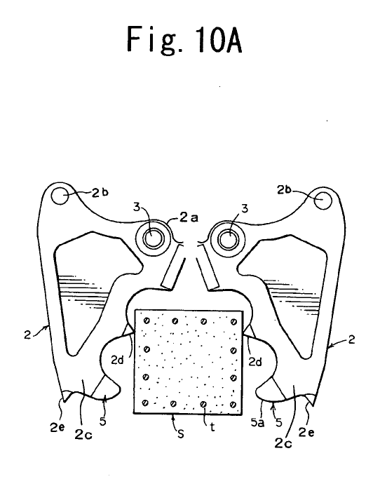

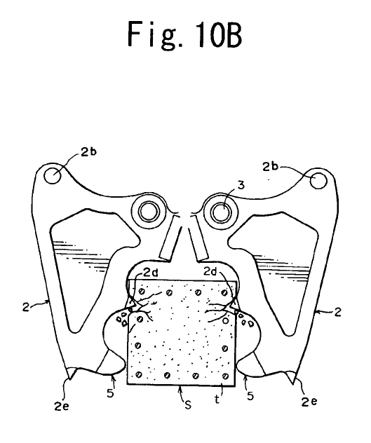

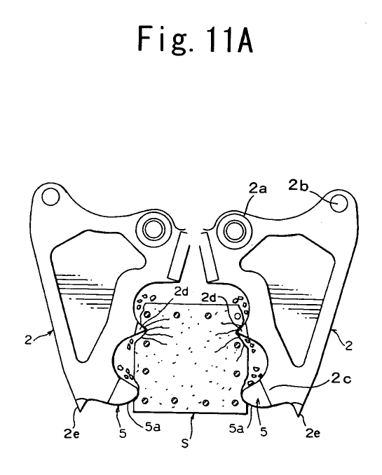

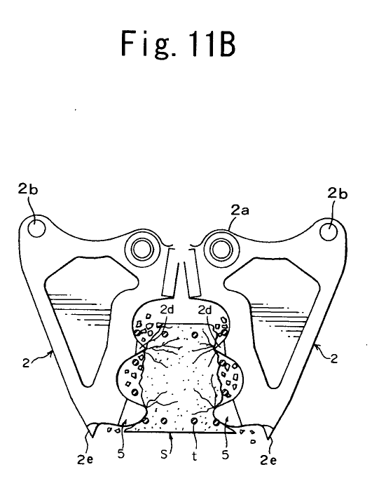

Next, a second embodiment of the present invention is described with reference to the drawings. As shown in FIG. 8 and FIG. 9, intermediate pressing portions 2d are formed in a protruding fashion in an intermediate position on a working surface of the movable jaw main body 2. The pointy ends of the intermediate pressing portions 2d are in a V-shape, and the blade lines at the pointy ends are configured so as to intersect with each other at right angles on the page space shown in FIG. 9. When crushing the RC object to be crushed (pillar, beam or the like), whose cross section is in the shape of a rough square, the pointy ends of the intermediate pressing portions 2d play a role of crushing the concrete, and of supporting the RC object to be crushed (pillar, beam or the like), as shown in FIG. 10A, FIG. 10B, FIG. 11A, and FIG. 11B. Moreover, protruding portions 2e, 2e are provided so as to be positioned on the pointy ends side from the pair of crushing bodies 5, 5 when the pair of movable jaw man bodies 2, 2 are closed. A slab such as a floor, ceiling or the like is crushed by the shoving work of the protruding portions 2e, 2e to bring the pair of movable jaw main bodies 2, 2 in a movable state.

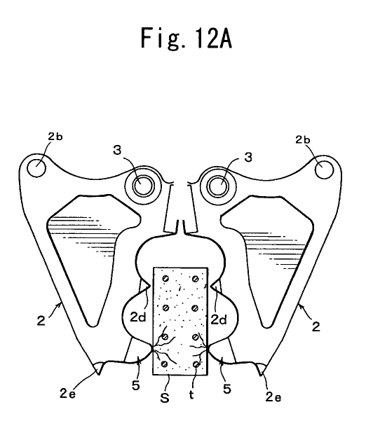

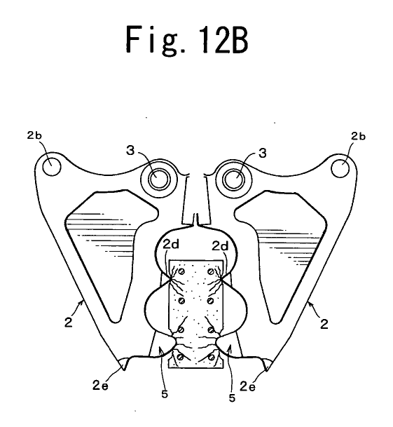

Further, when crushing a relatively thin RC object to be crushed (pillar, beam or the like), the pair of crushing bodies 5, 5 abut with the RC object to be crushed (pillar, beam or the like) before the protruding portions 2e, 2e do when the pair of movable jaw main bodies 2, 2 are closed, as shown in FIG. 12A and FIG. 12B. Particularly, the cutting blades 5a on the pointy ends of the pair of crushing bodies 5, 5 operate to cut the RC object to be crushed in half, and at the same time perform pressing and crushing along the longitudinal direction by means of the protruding portions 2e, 2e to crush the RC object into pieces. Of course, the pair of crushing bodies 5, 5 can perform this crushing work without causing reaction force for pushing the RC object to be crushed (pillar, beam or the like) out.

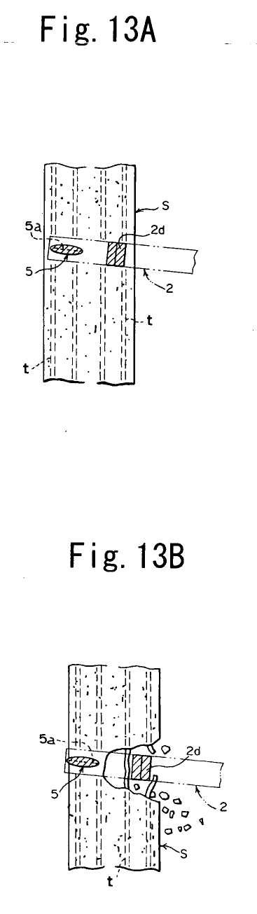

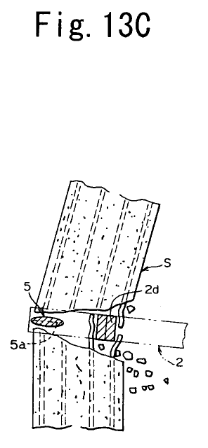

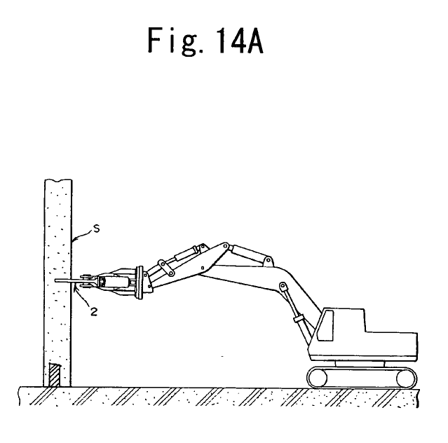

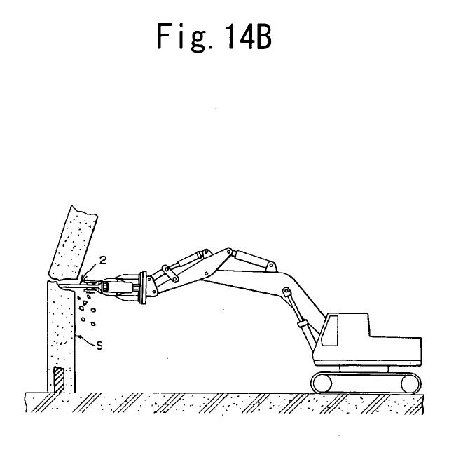

Also, even if the RC object to be crushed (pillar, beam or the like) of a building structure such as a building is crushed from the inside to the outside thereof using the crushing machine of the present invention, when the ratio of the small space ΔH to the maximum space Lₘₐₓ in the crushing machine is approximately 5% or less, as shown in FIG. 13A through FIG. 13C, FIG. 14A and FIG. 14B, the reaction force for pushing out the SRC object to be crushed or RC object to be crushed (pillar, beam or the like) is slightly generated or hardly generated. Therefore, serious drawbacks that the pillar or the like falls outside or that a part thereof falls outside during the crushing work can be resolved. Such a technology that seems simple can exhibit an outstanding effect of avoiding the cause of generation of a fatal and injury accident involving passers-by during a crushing work of a building to be torn down.

To describe this point in detail, when the ratio of the small space ΔH to the maximum space Lₘₐₓ is approximately 5% or less, in the crushing machine, the pressing direction of the pair of crushing bodies 5, 5 is configured such that breaking load is added, in a substantially horizontal direction in FIG. 7, to the steel s of a wide flange beam or flat steel bar of a pillar body of the SRC object to be crushed S or a RC object to be crushed (pillar, beam or the like), and such that nearly no component force for pushing out to the front (force for pushing out downward in the page space in FIG. 7) is generated. Accordingly, there is an advantage that nearly no reaction force for pushing out the pillar body as a general SRC object to be crushed S or RC object to be crushed (pillar, beam or the like) is caused to act, and that the drawbacks that the pillar and the like fall outside or a part thereof falls outside during a crushing work can be avoided, in the manners shown in FIG. 13A through FIG. 13C, FIG. 14A and FIG. 14B.

Since such a crushing work can be performed in the manner as above, the present invention can quickly and safely crush the SRC object to be crushed S (pillar, beam or the like) of SRC buildings or the like that will increase in our country in the future. Moreover, the present invention can provide a crush field which is extremely useful in large numbers of RC objects to be crushed (pillar, beam and the like) that exist today, and can be applied in a wide application range and provided as a leader in crushing concrete in the future.

1. A crushing machine, wherein a crushing machine outer case is provided with a pair of movable jaw main bodies which swing face to face with each other, base portions of the pair of movable jaw main bodies are provided at a pair of pivotally supporting portions which are separated from each other by a predetermined spacing, and crushing bodies are fixed to the pointy ends of said pair of movable jaw main bodies, the movable jaw main bodies being configured so as to be openable and closable by means of respective hydraulic cylinders.

2. The crushing machine according to claim 1, wherein crushing blade lines of the crushing bodies are formed so as to follow the longitudinal direction of said movable jaw main bodies.

3. The crushing machine according to claim 1, wherein an intermediate pressing portion is formed in a protruding fashion in an intermediate position, on a working surface side, between the pointy end and base portion of each of said movable jaw main bodies.

4. A crushing method by means of a crushing machine, wherein crushing bodies are provided on the pointy ends of a pair of movable jaw main bodies which swing face to face with each other in a crushing machine outer case, and crushing blade lines of the crushing bodies are formed so as to follow the longitudinal direction of said movable jaw main bodies, thereby crushing an SRC object to be crushed or
an RC object to be crushed such as a pillar or beam after pinching the pillar or beam such that the crushing blade lines of said crushing bodies intersect to the longitudinal direction of the object to be crushed, and repeatedly crushing the intersecting part.

5. The crushing method by means of the crushing machine according to claim 4, wherein little amount of reaction force for pushing out the SRC object to be crushed or RC object to be crushed is generated when closing said pair of movable jaws main bodies in the case of crushing a building starting from the inside to the outside thereof.

6. The crushing method by means of the crushing machine according to claim 5, wherein with respect to the maximum space of said both pointy ends of the crushing bodies when said movable jaw main bodies are opened to the maximum, the ratio of the small space, created when gradually closing said movable jaw main bodies so that said both pointy ends of the crushing bodies come to the front-most positions, is approximately 5% or less.

7. The crushing machine according to claim 2, wherein an intermediate pressing portion is formed in a protruding fashion in an intermediate position, on a working surface side, between the pointy end and base portion of each of said movable jaw main bodies.
